(19) United States
(12) Patent Application Publication
(10) Pub. No.: US 2024/0367242 A1
(43) Pub. Date: Nov. 7, 2024

(54) RETRIEVAL OF TUBULAR STRINGS FROM SUBTERRANEAN WELLS

(71) Applicant: WEATHERFORD TECHNOLOGY HOLDINGS, LLC, HOUSTON, TX (US)

(72) Inventor: Warwick LOW, Perth (AU)

(21) Appl. No.: 18/312,068

(22) Filed: May 4, 2023

(51) Int. Cl. B23D 21/00; B23D 17/00; E21B 19/00; E21B 41/00

(52) U.S. Cl. CPC B23D 21/00; B23D 17/00; E21B 19/00; E21B 41/00

(57) ABSTRACT

A tubular shear assembly for use with a subterranean well can include a tubular shear device configured to shear a tubular string that extends into the well. The tubular shear device can include a body, a fixed shear jaw, and a rotary shear jaw configured to rotate relative to the body and the fixed shear jaw to shear the tubular string. A method of retrieving a tubular string from a subterranean well can include displacing a tubular shear device, including positioning the tubular string between a fixed shear jaw of the tubular shear device and a rotary shear jaw of the tubular shear device, and rotating the rotary shear jaw relative to the fixed shear jaw, thereby shearing the tubular string.

### BACKGROUND

This disclosure relates generally to equipment utilized and operations performed in conjunction with a subterranean well and, in an example described below, more particularly provides for efficient retrieval of tubular strings from subterranean wells.

In well operations, it is sometimes necessary to retrieve a tubular string (such as, a production or injection tubing string) from the well. Typically, a retrieved section of the tubular string is unthreaded from another section that remains in the well, and then the section that remained in the well is raised, and the steps are repeated until all of the tubular string has been retrieved.

Therefore, it will be readily appreciated that improvements are continually needed in the arts of constructing equipment for retrieval of tubular strings, and performing methods of retrieving tubular strings. The following disclosure provides such improvements to the arts, which may be used in a variety of different well operations.

### BRIEF DESCRIPTION OF THE DRAWINGS

FIG. 1 is a representative partially cross-sectional view of an example of a well system and associated method which can embody principles of this disclosure.

FIG. 2 is a representative elevational view of an example of a tubular shear assembly that may be used with the FIG. 1 system and method.

FIG. 3 is a representative top view of a tubular shear device that may be used in the FIG. 2 tubular shear assembly.

FIG. 4 is a representative perspective view of another example of the tubular shear assembly incorporating a tubular handling device.

FIG. 5 is a representative perspective view of the FIG. 4 tubular shear assembly after shearing of a tubular.

### DETAILED DESCRIPTION

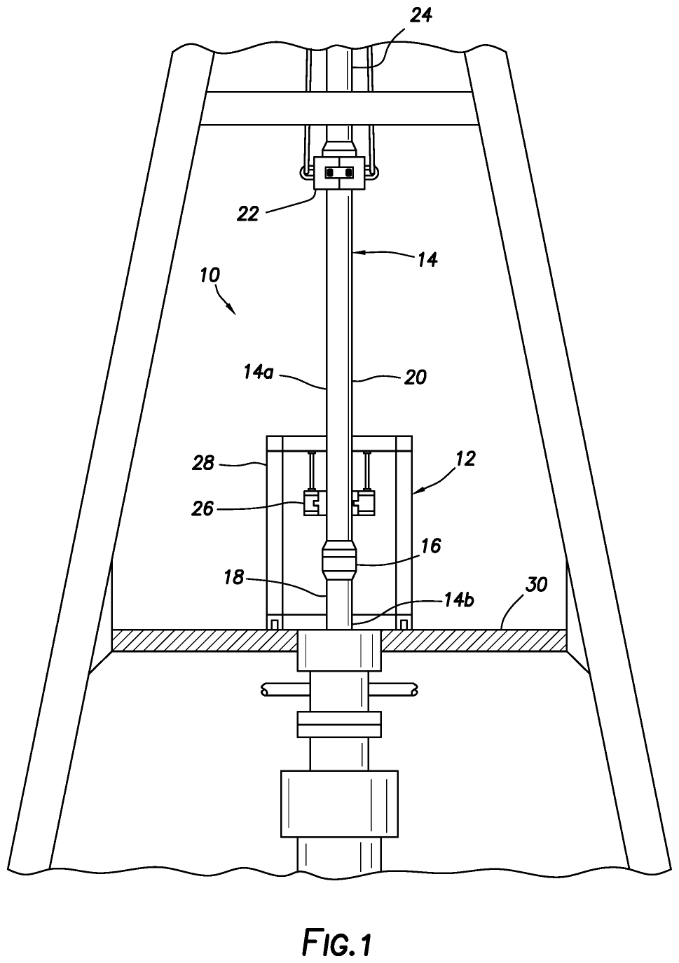

Representatively illustrated in FIG. 1 is a system 10 for use with a subterranean well, and an associated method, which can embody principles of this disclosure. However, it should be clearly understood that the system 10 and method are merely one example of an application of the principles of this disclosure in practice, and a wide variety of other examples are possible. Therefore, the scope of this disclosure is not limited at all to the details of the system 10 and method described herein and/or depicted in the drawings.

In the FIG. 1 example, a tubular shear assembly 12 is used to shear a tubular string 14 as it is being retrieved from a well. In this manner, threaded connections 16 between tubulars 18, 20 do not need to be unthreaded from each other as the tubular string 14 is retrieved from the well. The threaded connection 16 depicted in FIG. 1 is a connection between internally and externally threaded ends of the tubulars 18, 20, but in other examples a coupling may be used to connect externally threaded ends of the tubulars.

The tubular string 14 may comprise any type or combination of tubulars 18, 20, such as, production tubing, injection tubing, casing, liner, pipe, etc. The scope of this disclosure is not limited to use of the tubular shear assembly 12 with any particular type of tubular or pipe.

As depicted in FIG. 1, an elevator 22 is used to raise and suspend the tubular string 14. The elevator 22 may be connected to a top drive or a draw-works (not shown). The tubular string 14 in this example is raised to a position in which the upper tubular 20 can be sheared by the tubular shear assembly 12 at a location above the threaded connection 16.

When the upper tubular 20 is sheared by the tubular shear assembly 12, one or more additional full or partial tubulars 24 may be connected to the upper tubular 20. Thus, when an upper section 14a of the tubular string 14 is separated from a lower section 14b of the tubular string by the shearing of the tubular 20, the upper section 14a may comprise more than one tubular member.

In the FIG. 1 example, it is advantageous to shear the upper tubular 20 at the location above the threaded connection 16 so that, after the shearing of the upper tubular 20 and laying down of the upper section 14a of the tubular string 14, the elevator 22 can be conveniently secured to the lower section 14b at a location just below the threaded connection. However, it is not necessary for the tubular string 14 to be sheared just above the threaded connection 16, or for the tubular string to be sheared at any particular location relative to any threaded connection, in keeping with the principles of this disclosure.

As depicted in FIG. 1, the tubular shear assembly 12 includes a tubular shear device 26 secured to a frame 28. The frame 28 is movable laterally relative to the tubular string 14 on a rig floor 30. In some examples, the frame 28 can be configured to displace along tracks (not shown) in the rig floor 30, similar to the manner in which equipment known to those skilled in the art as an “iron roughneck” is displaced on a rig floor. However, the scope of this disclosure is not limited to any particular manner of displacing the frame 28 on the rig floor 30.

In other examples, the tubular shear device 26 may not be secured to a frame. For example, the tubular shear device 26 could instead be suspended from a jib crane or another hoisting device, or could be displaced laterally using any type of actuator (e.g., a mechanical, hydraulic or electric actuator). Thus, the scope of this disclosure is not limited to use of the tubular shear device 26 with the frame 28.

In a method of retrieving the tubular string 14 from the well, the following steps may be performed:
1. The elevator 22 is latched to the upper tubular 20 (or another tubular 24 connected above the tubular 20). The elevator 22 is raised somewhat, until the elevator supports the weight of the tubular string 14.
2. Slips (not shown) in the rig floor 30 are released.
3. The tubular string 14 is raised until a desired shear location on the upper tubular 20 is laterally aligned with the tubular shear device 26. As discussed above, the desired shear location may be just above the threaded connection 16.
4. The slips in the rig floor 30 are set, so that they grip the lower tubular 18 to prevent downward displacement of the lower tubular.
5. The elevator 22 is lowered somewhat, so that the slips support the weight of the tubular string 14.
6. The tubular shear assembly 12 is moved laterally toward the tubular string 14, until the upper tubular 20 is positioned between shear jaws of the tubular shear device 26. As described above, the frame 28 may be displaced along the rig floor 30 to position the tubular shear device 26 at the desired shear location.
7. The tubular shear device 26 is actuated to shear the upper tubular 20, thereby separating the upper section 14a of the tubular string 14 from the lower section 14b.
8. The elevator 22 is used to lay down the upper section 14a.
9. The tubular shear assembly 12 is displaced laterally away from the remaining lower section 14b. Steps 8 and 9 may be performed together.
10. The elevator 22 is latched to the lower section 14b just below the threaded connection 16, and the above steps are repeated until all (or a desired length of) the tubular string 14 is retrieved from the well.

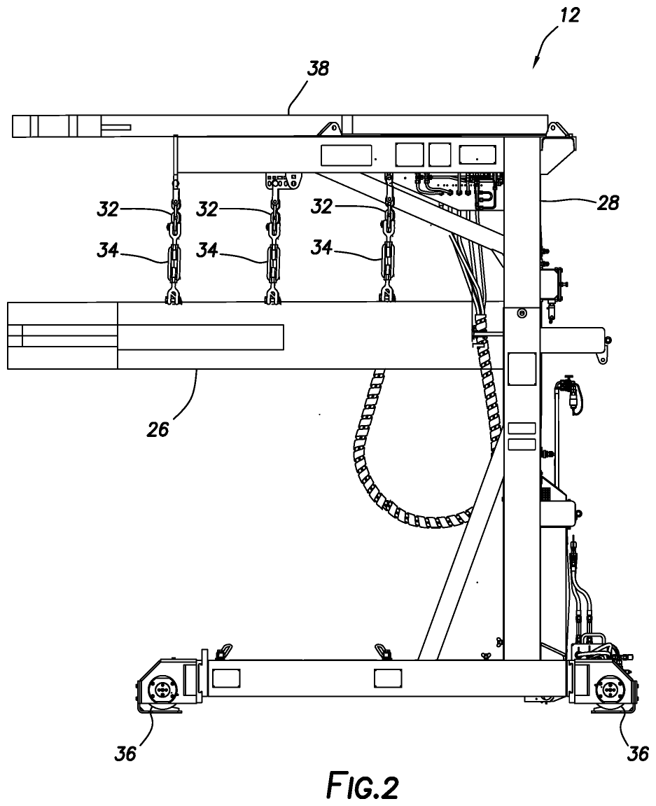

Referring additionally now to FIG. 2, a more detailed side view of an example of the tubular shear assembly 12 is representatively illustrated. The FIG. 2 tubular shear assembly 12 is described below as it may be used with the system 10 and method of FIG. 1, but the tubular shear assembly may be used with other systems and methods in keeping with the principles of this disclosure.

In the FIG. 2 example, the tubular shear device 26 is suspended from the frame 28 with multiple lengths of chain 32 and adjustable turnbuckles 34. In other examples, the tubular shear device 26 may be secured to the frame 28 in a different manner.

The FIG. 2 frame 28 includes wheels 36 for displacing the frame on the rig floor 30 (see FIG. 1). The wheels 36 may be dimensioned and spaced apart to cooperatively engage tracks (not shown) in the rig floor 30 as described above. However, the scope of this disclosure is not limited to any particular manner of laterally displacing the tubular shear device 26 or frame 28.

The FIG. 2 tubular shear assembly 12 includes a tubular handling device 38 secured to the frame 28 above the tubular shear device 26. The tubular handling device 38 is used to retain the tubular string 14 (see FIG. 1) during the shearing of the tubular string, and to laterally displace the upper section 14a after the shearing of the tubular string, as described more fully below.

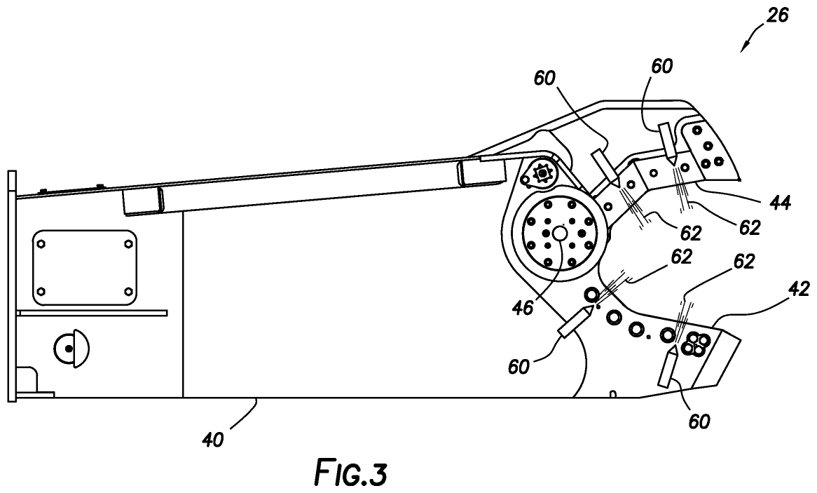

Referring additionally now to FIG. 3, a top view of an example of the tubular shear device 26 is representatively illustrated. The FIG. 3 tubular shear device 26 may be used with the FIG. 1 system 10 and method, or with the FIG. 2 tubular shear assembly, but the FIG. 3 tubular shear device may alternatively be used with other systems, methods and tubular shear assemblies.

In the FIG. 3 example, the tubular shear device 26 includes a body 40, a fixed shear jaw 42 and a rotary shear jaw 44. The rotary shear jaw 44 is rotatable about a pivot 46 in the body 40. The fixed shear jaw 42 does not rotate, but is instead stationary relative to the body 40.

The rotary jaw 44 may be rotated by means of an actuator (not shown), such as a hydraulic or electrical actuator positioned in the body 40. However, the scope of this disclosure is not limited to any particular manner of rotating the rotary shear jaw 44 about the pivot 46.

When used in the FIG. 1 system 10 and method, the tubular shear device 26 is displaced laterally toward the tubular string 14, until the desired shear location is positioned between the shear jaws 42, 44. The rotary shear jaw 44 is then rotated about the pivot 46 (for example, by actuating a hydraulic or electrical actuator in the body 40), until the tubular 20 is sheared by the jaws 42, 44. The rotary shear jaw 44 is then rotated back to its open position as depicted in FIG. 3.

The shear device 26 may in some examples be provided with optional nozzles 60 for spraying water mist 62 about the shear location. The water mist 62 may be sprayed while the shear device 26 is being used to shear through the tubular 20, in order to suppress any sparks that may be generated by the shearing operation.

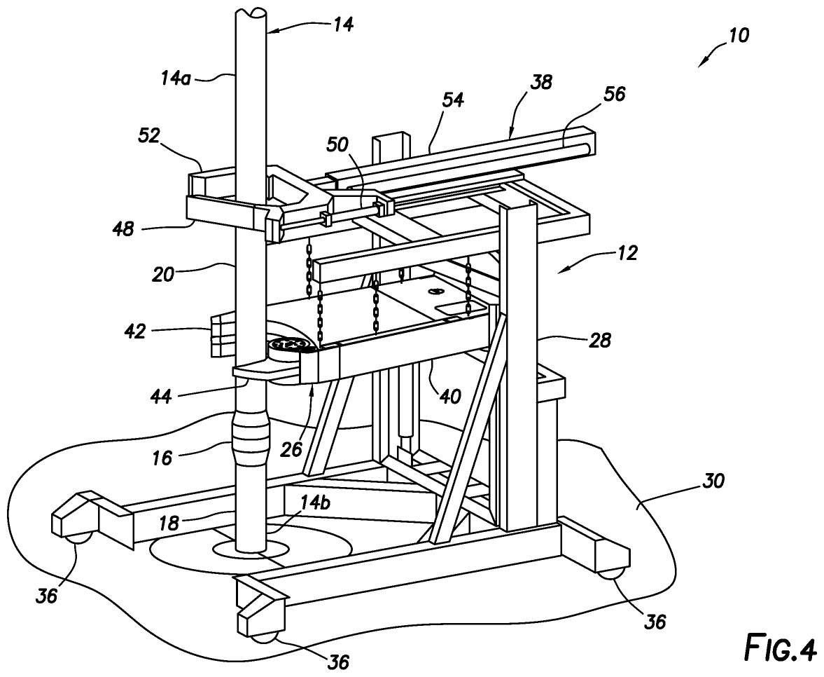

Referring additionally now to FIG. 4, a perspective view of another example of the tubular shear assembly 12 incorporating the tubular handling device 38 is representatively illustrated. The FIG. 4 tubular shear assembly 12 is described below as it may be used with the system 10 and method of FIG. 1, but the FIG. 4 tubular shear assembly may alternatively be used with other systems and methods in keeping with the scope of this disclosure.

As depicted in FIG. 4, the tubular shear assembly 12 has been displaced laterally toward the tubular string 14, so that the upper tubular 20 is now positioned between the fixed and rotary shear jaws 42, 44 of the tubular shear device 26. The tubular string 14 is retained by a gate 48 in a receiver 52 of the tubular handling device 38.

The gate 48 in this example is pivoted between open and closed positions by an actuator 50 of the tubular handling device 38. The gate 48 is rotated to its open position when the tubular shear assembly 12 is displaced toward or away from the tubular string 14, and the gate is rotated to its closed position (as depicted in FIG. 4) to retain the tubular string 14 (or at least the upper section 14a thereof) during and after the shearing of the tubular string.

The gate 48 and the receiver 52 are connected at an end of a telescoping extension 54 of the tubular handling device. An actuator 56 can be used to laterally extend the gate 48 and receiver 52 after the upper tubular 20 has been sheared, in order to assist in laying down the upper section 14a of the tubular string 14. Thus, the tubular handling device 38 has retracted and extended configurations, with the retracted configuration being depicted in FIG. 4.

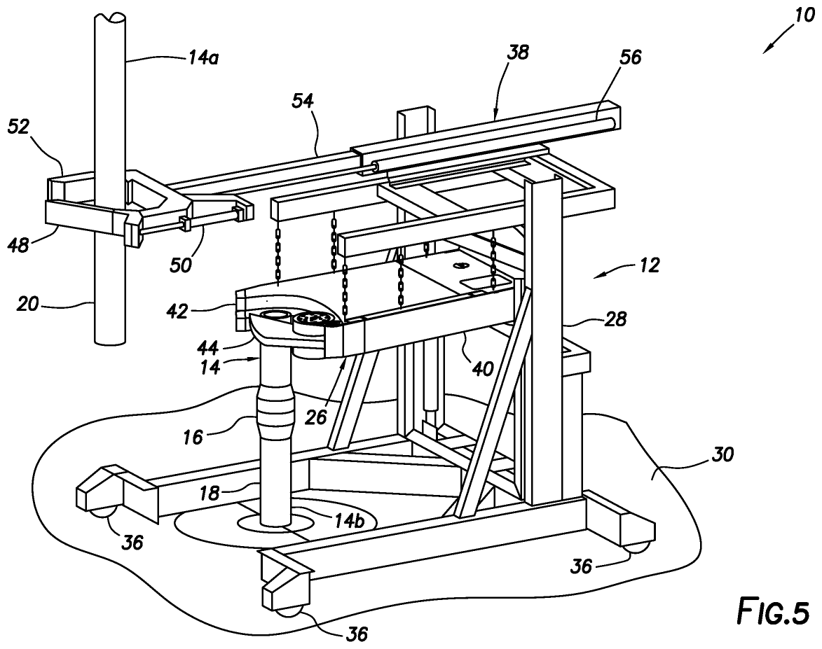

Referring additionally now to FIG. 5, the FIG. 4 tubular shear assembly 12 is representatively illustrated after the upper tubular 20 has been sheared and the actuator 56 has been actuated to extend the extension 54 and thereby place the tubular handling device 38 in its extended configuration. The upper section 14a of the tubular string 14 is now separated from the lower section 14b, and the upper section 14a is laterally displaced away from the tubular shear device 26 and frame 28.

The elevator 22 (see FIG. 1) can now be lowered to lay down the upper section 14a. The gate 48 can be opened by use of the actuator 50 to rotate the gate relative to the receiver 52, so that the upper section 14a is no longer retained with the tubular handling device 38.

The rotary jaw 44 can be rotated back to its open position and the tubular shear assembly 12 can be displaced laterally away from the tubular string 14. The elevator 22 can then be latched below the threaded connection 16 to repeat the process as described above.

It may now be fully appreciated that the above disclosure provides significant advancements to the arts of constructing equipment for retrieval of tubular strings, and performing methods of retrieving tubular strings. In examples described above, the tubular shear assembly 12 can be used to quickly and conveniently separate sections 14a,b of the tubular string 14, without the need of unthreading any connections 16 between tubulars 18, 20.

The above disclosure provides to the arts a tubular shear assembly 12 for use with a subterranean well. In one example, the tubular shear assembly 12 can comprise a tubular shear device 26 configured to shear a tubular string 14 that extends into the well. The tubular shear device 26 includes a body 40, a fixed shear jaw 42 and a rotary shear jaw 44. The rotary shear jaw 44 is configured to rotate relative to the body 40 and the fixed shear jaw 42 to shear the tubular string 14.

The tubular shear assembly 12 can include a frame 28 configured to displace laterally relative to the tubular string 14. The tubular shear device 26 may be secured to the frame 28. The tubular shear device 26 may be suspended from the frame 28.

The tubular shear assembly 12 may include a tubular handling device 38 secured to the frame 28. The tubular handling device 38 may include a first actuator 56 configured to displace a section 14a of the tubular string 14 laterally relative to the frame 28.

The tubular handling device 38 may include a gate 48 configured to retain the tubular string section 14a with the tubular handling device 38, and a second actuator 50 configured to displace the gate 48 between open and closed positions.

The rotary shear jaw 44 may be configured to rotate about a pivot 46 secured to the body 40. The fixed shear jaw 42 may not be rotatable relative to the pivot 46.

The above disclosure also provides to the arts a method of retrieving a tubular string 14 from a subterranean well. In one example, the method can comprise: displacing a tubular shear device 26, the displacing step including positioning the tubular string 14 between a fixed shear jaw 42 of the tubular shear device 26 and a rotary shear jaw 44 of the tubular shear device 26, and rotating the rotary shear jaw 44 relative to the fixed shear jaw 42, thereby shearing the tubular string 14.

In the step of shearing of the tubular string 14, the fixed shear jaw 42 may not rotate. The step of displacing the tubular shear device 26 may include displacing a frame 28, with the tubular shear device 26 being secured to the frame 28. The tubular shear device 26 may be suspended from the frame 28.

The method may include closing a gate 48 of a tubular handling device 38 prior to the shearing step, thereby retaining the tubular string 14 with the tubular handling device 38.

The method may include actuating the tubular handling device 38, thereby laterally displacing a sheared section 14a of the tubular string 14 relative to the tubular shear device 26, after the shearing step.

The rotating step may include rotating the rotary shear jaw 44 about a pivot 46 in a body 40 of the tubular shear device 26. The fixed shear jaw 42 may not rotate about the pivot 46.

Another example of the tubular shear assembly 12 described above can include a frame 28 configured to displace laterally relative to a tubular string 14 that extends into a well, and a tubular shear device 26 configured to shear the tubular string 14. The tubular shear device 26 can include a body 40 configured to displace laterally with the frame 28, a fixed shear jaw 42, and a rotary shear jaw 44 configured to rotate relative to the body 40 and the fixed shear jaw 42 to shear the tubular string 14.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

It should be understood that the various embodiments described herein may be utilized in various orientations, such as inclined, inverted, horizontal, vertical, etc., and in various configurations, without departing from the principles of this disclosure. The embodiments are described merely as examples of useful applications of the principles of the disclosure, which is not limited to any specific details of these embodiments.

In the above description of the representative examples, directional terms (such as “above,” “below,” “upper,” “lower,” “upward,” “downward,” etc.) are used for convenience in referring to the accompanying drawings. However, it should be clearly understood that the scope of this disclosure is not limited to any particular directions described herein.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. A tubular shear assembly for use with a subterranean well, the tubular shear assembly comprising:
a tubular shear device configured to shear a tubular string that extends into the well, the tubular shear device comprising:
a body;
a fixed shear jaw; and
a rotary shear jaw configured to rotate relative to the body and the fixed shear jaw to shear the tubular string.

2. The tubular shear assembly of claim 1, further comprising a frame configured to displace laterally relative to the tubular string, and in which the tubular shear device is secured to the frame.

3. The tubular shear assembly of claim 2, in which the tubular shear device is suspended from the frame.

4. The tubular shear assembly of claim 2, further comprising a tubular handling device secured to the frame, the tubular handling device comprising a first actuator configured to displace a section of the tubular string laterally relative to the frame.

5. The tubular shear assembly of claim 4, in which the tubular handling device further comprises a gate configured to retain the tubular string section with the tubular handling device, and a second actuator configured to displace the gate between open and closed positions.

6. The tubular shear assembly of claim 1, in which the rotary shear jaw is configured to rotate about a pivot secured to the body.

7. The tubular shear assembly of claim 6, in which the fixed shear jaw is not rotatable relative to the pivot.

8. A method of retrieving a tubular string from a subterranean well, the method comprising:
displacing a tubular shear device, the displacing comprising positioning the tubular string between a fixed shear jaw of the tubular shear device and a rotary shear jaw of the tubular shear device; and
rotating the rotary shear jaw relative to the fixed shear jaw, thereby shearing the tubular string.

9. The method of claim 8, in which in the shearing of the tubular string, the fixed shear jaw does not rotate.

10. The method of claim 8, in which the displacing of the tubular shear device comprises displacing a frame, the tubular shear device being secured to the frame.

11. The method of claim 8, in which the displacing of the tubular shear device comprises displacing a frame, the tubular shear device being suspended from the frame.

12. The method of claim 8, further comprising closing a gate of a tubular handling device prior to the shearing, thereby retaining the tubular string with the tubular handling device.

13. The method of claim 12, further comprising actuating the tubular handling device, thereby laterally displacing a sheared section of the tubular string relative to the tubular shear device, after the shearing.

14. The method of claim 8, in which the rotating comprises rotating the rotary shear jaw about a pivot in a body of the tubular shear device, and in which the fixed shear jaw does not rotate about the pivot.

15. A tubular shear assembly for use with a subterranean well, the tubular shear assembly comprising:
a frame configured to displace laterally relative to a tubular string that extends into the well; and
a tubular shear device configured to shear the tubular string, the tubular shear device comprising:
a body configured to displace laterally with the frame;
a fixed shear jaw; and
a rotary shear jaw configured to rotate relative to the body and the fixed shear jaw to shear the tubular string.

16. The tubular shear assembly of claim 15, in which the tubular shear device is suspended from the frame.

17. The tubular shear assembly of claim 15, further comprising a tubular handling device secured to the frame, the tubular handling device comprising a first actuator configured to displace a section of the tubular string laterally relative to the frame.

18. The tubular shear assembly of claim 17, in which the tubular handling device further comprises a gate configured to retain the tubular string section with the tubular handling device, and a second actuator configured to displace the gate between open and closed positions.

19. The tubular shear assembly of claim 15, in which the rotary shear jaw is configured to rotate about a pivot secured to the body.

20. The tubular shear assembly of claim 19, in which the fixed shear jaw is not rotatable relative to the pivot.
